(19) United States
(12) Patent Application Publication
(10) Pub. No.: US 2003/0224091 A1
(43) Pub. Date: Dec. 4, 2003

(54) Rice Packaging

(76) Inventor: Sivoush Nayyeri, Irvine, CA (US)

Correspondence Address: WALTER A. HACKLER, 2372 S.E. BRISTOL, SUITE B, NEWPORT BEACH, CA, 92660-0755, US

(21) Appl. No.: 10/160,768

(22) Filed: Jun. 3, 2002

(51) Int. Cl. A23B 4/00

(52) U.S. Cl. 426/118

(57) ABSTRACT

A bag for enabling storage of rice without insect infestation includes a top and bottom member formed from a plastic and sealed to one another along a perimeter. A one-way valve is disposed in one of the top and bottom members for enabling air release from the bag which prevents incubation and proliferation of infestation.

The present invention is generally directed to bags and a bag storage system for protecting cereals, such as rice, from insect pests and is more specifically directed to plastic bags for retail sale of rice and consumer use.

Rice is commonly infested with Sitophilus Oryzae and incubation of such pests commonly occurs when rice is disposed in a sealed environment, such as a plastic bag.

Treatment of rice before packaging by way of fumigation or spraying of insecticides and the like typically are inefficient in ridding cereals, such as rice, completely from the pests. Further, rice contaminated by such insecticides may not be desirable for human consumption.

Accordingly, rice is not packaged within a sealed plastic bag, pouch or container, but rather cloth bags or breathable paper packaging is utilized.

This type of packaging is, however, is not amenable to graphic printing which is desirable from a marketing standpoint.

The present invention is directed to a plastic bag storage system, which enables the use of impermeable plastics suitable for graphic printing, while at the same time enabling storage rice for long periods of time without insect infestation, that is, the proliferation of Sitophilus Oryzae or the like.

### SUMMARY OF THE INVENTION

A bag for enabling storage of cereals, such as rice, without insect infestation in accordance with the present invention generally includes a top member formed from a plastic material and having a perimeter along with a bottom member formed from a plastic material and having a perimeter conforming to the top member perimeter. The perimeters are sealed to one another.

A quantity of rice disposed in the bag causes a bulged center portions in the top and bottom members as well as arcuate edge portions subtending the bulge portion and the sealed perimeters. A one-way valve is disposed in either the top or the bottom member for enabling air-release from the bag. Unexpectedly, this ability to vent air from the bag enables long term storage of the rice without the growth of Sitophilus Oryzae or other organisms.

Preferably, the one-way valve is disposed in the arcuate edge portion, thereby enabling stacking or piling of the bags for storage upon one another without blocking the valve.

The use of plastic enables sharp graphic printing thereon which is desirable for marketing of the rice bags. Suitable plastic include, but are not limited to polyethylene, polypropylene and polyvinyl chloride, as examples.

Preferably, the top and bottom member perimeters are rectilinear and have one side with a hand resealable seal. This enables daily use of the rice disposed in the bags and upon further storage of a resealed bag the one-way valve continues to function in releasing air from within the bag.

A bag storage system in accordance with the present invention includes a plurality of bags each having a top member formed from a plastic having a perimeter and a bottom member formed from a plastic having a perimeter conforming to the top member perimeter. Each of the bag perimeters are sealed to one another and a quantity of rice is disposed at each bag for causing a bulged center portion in the top and portion bottom of each bag along with arcuate edge portions subtending corresponding bulged portion and respective sealed perimeters.

One-way valves are disposed on the top and bottom members of each bag for enabling air released from each bag with the bags stacked upon one another for storage with the bulged portion in contact with one another. This system enables long term storage of the bags in warehouses and in retail stores. As hereinabove noted, air escape is facilitated by the disposition of the one-way valve in an arcuate edge portion of each bag. Further, each bag may include a hand resealable seal for maintaining a sealed environment after purchase and initial use by a consumer.

A method in accordance with the present invention for producing a bag for protecting rice from insect pests harmful to stored rice includes forming a bag from a top and bottom member by sealing the top and bottom members all on perimeters thereof and disposing a one-way valve in one of the top and bottom members proximate the perimeter thereof. The one-way valve is oriented for enabling air release from the bag but preventing air entry into the bag after sealing along the perimeters.

Further, a method of storing rice, in accordance with the present invention, in a manner protecting the stored rice, from insect pests harmful to stored rice, includes forming a bag from a top and bottom member by sealing the top and bottom members along a bottom and sides thereof. A one-way valve is disposed in one of the top and bottom members proximate the perimeters and the formed bag is filled with rice and thereafter sealed along the top thereof.

### BRIEF DESCRIPTION OF THE DRAWINGS

The advantages and features of the present invention will be better understood by the following description when considered in conjunction with the accompanying drawings in which:

FIG. 1 is a perspective view of a bag and bag system in accordance with the present invention generally showing bags formed from top and bottom members sealed along perimeters thereof and including a one-way valve disposed in an arcuate edge portion of each bag proximate the sealed perimeter, the bags each having a bulged center portion caused by rice filling;

FIG. 2 is a side view of a plurality of bags as they may be stored by piling upon one another showing a placement of a one-way valve proximate a sealed perimeter and away from bulged center portions of the bags for enabling free escape of air from the bags on storage; and

FIG. 3 is an enlarge cross section view of a valve suitable for use in the present invention.

### DETAILED DESCRIPTION

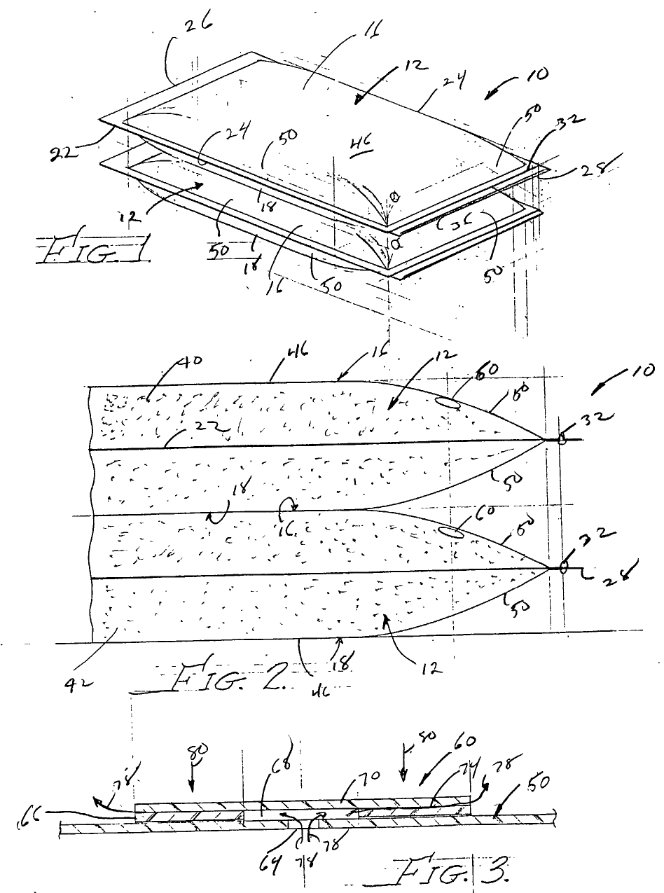

With reference to FIGS. 1 and 2 there is shown a bag storage system 10 in accordance with the present invention which includes a plurality of bags 12 for enabling storage of rice without significant insect infestation.

Each of the bags 12 include top members 16 and bottom members 18 formed from a plastic material such as, for example, as hereinabove noted, polyethylene, polypropylene, or polyvinyl chloride. These plastics are suitable for sharp graphic printing thereon in any manner as is well known in the art of plastic printing.

The top and bottom member 16, 18 are sealed along a perimeter 22 which may include side perimeters 24, a bottom perimeter 26 and a top perimeter 28 when the bags are in rectilinear shape as shown in FIG. 1. The perimeter 22 may be sealed in any suitable manner.

In addition, a well known hand resealable “zip-lock” type seal 32 may be provided for resealing of the bag after initial use by a consumer with access provided by cutting the perimeter 28 between a top seal and a zip-lock seal 32. Quantities of rice 40, 42, shown in dashed dots in FIG. 2, cause a bulged center portion 46 in the top and bottom portions 16, 18 and arcuate edge portions 50 subtending the bulged portion 46 and the sealed perimeter.

One-way valves 60 are disposed in the arcuate edge portions 50 proximate the perimeter 22 of each bag for enabling air release from the bag but preventing air entry into the bag. Preferably, as shown, the one-way valves 60 are disposed in the arcuate edge portions 50 for enabling piling, or stacking, of the bags 12, as shown in FIGS. 1 and 2 upon one another with the bulged center portions 46 abutting one another. This placement allows a free exhaust of air from the bags through the valves 60 without interference by contact with other bags 12.

A suitable one-way valves 60 is shown in FIG. 3. The valve 60 is disposed over an opening 64 in the arcuate portion 50 and includes an adhesive ring 66 having an open center 68 and a plastic cover 70 which is releasably adhered to a top 74 of the adhesive. The cover 70 clings to the adhesive 74 sufficient to prevent removal thereof, however, enables the passage of air from the bag as indicated by the arrows 78. Reverse air pressure indicated by the arrows 80 act to tighten the contact between the cover 70 and the adhesive ring 66, thus preventing entry of air into the bag 12.

As hereinabove noted, the bags are formed from a plastic material which is impervious to air and moisture and heretofore, storage in such a sealed container caused incubation and proliferation of infestation, such as, for example Sitophilus Oryzae. Surprisingly, by providing a vent in the bag incubation and cultivation of infestation is prevented or substantially reduced. The following example is provided for illustrating the effectiveness of the present invention for the storage of rice without insect infestation.

### EXAMPLE

Plastic bags made in accordance with the present invention, but without the seal 60 were filled with ten pounds of basmati rice and stored at temperatures of up to 120° along with bags constructed in accordance with the present invention with the one-way valves 60.

After a period of 16 weeks the bags without valve 60 were opened and the rice examined and found to be heavily contaminated with Sitophilus Oryzae. This is to be contrasted with bags in accordance with the present invention with the one-way valves which were stored with ten pounds of basmati rice for a period of 12 months and thereafter opened and examined. The rice store in the bags with the one-way valves 60 showed little or no infestation of Sitophilus Oryzae.

A method in accordance with the present invention for producing a bag for protecting cereal such as rice from insect pests harmful to stored rice includes forming a bag from a top and a bottom member by sealing the top and bottom members along a perimeter thereof and disposing a one-way valve in one of the top and bottom members proximate the perimeter of. In addition, a method for storing rice in a manner protecting stored rice from insect pests includes forming a bag from a top and bottom member by sealing the top and bottom members along a bottom and sides thereof, disposing a one-way valve in each of the top and bottom member proximate the perimeter, filling the form bag with rice and sealing the filled bag along a top thereof.

Although there has been hereinabove described a bag, bag system and method in accordance with the present invention for the storage of rice without infestation for the purpose of illustrating the manner in which the invention may be used to advantage, it should be appreciated that the invention is not limited thereto. Accordingly, any and all modifications, variations or equivalent arrangements which may occur to those skilled in the art, should be considered to be within the scope of the present invention as defined in the appended claims.

What is claimed is:

1. A bag for enabling storage of rice without insect infestation, said bag comprising:
a top member formed from a plastic material and having a perimeter;
a bottom member formed from a plastic material and having a perimeter conforming to the top member perimeter, the perimeters being sealed to one another;
a quantity of rice disposed in said bag causing a bulged center portion in the top and bottom members and arcuate edge portion subtending the bulged portions and the sealed perimeters; and
a one-way valve disposed in one of the top and bottom members for enabling air release from the bag.

2. The bag according to claim 1 wherein the one-way is disposed in an arcuate edge portion to enable stacking of bags for storage without blocking the valve.

3. The bag according to claim 2 wherein the plastic material of the top and bottom member comprise a plastic enabling sharp graphic printing thereon.

4. The bag according to claim 3 wherein the top and bottom member perimeters are rectilinear and having one side having a hand resealable seal.

5. A bag storage system for enabling storage of rice without insect infestation, the system comprising:
a plurality of bags, each bag comprising;
a top member formed from a plastic material and having a perimeter;
a bottom member formed from a plastic material and having a perimeter conforming to the top member perimeter, the perimeters being sealed to one another;
a quantity of rice disposed in each bag causing a bulged center portion in the top and bottom portion of each bag and arcuate edge portions subtending the bulged portion and respective sealed perimeter; and
a one-way valve disposed in one of the top and bottom member of each bag for enabling air release from each of the bags with the bags stacked on one another for storage with the bulged portion in contact with one another.

6. The system according to claim 5 wherein the one-way valve are disposed in arcuate edge portion of each bag.

7. The system according to claim 6 wherein the plastic material of the top and bottom portions of each bag comprise a plastic enabling sharp graphic printing thereon.

8. The system according to claim 7 wherein the top and bottom member perimeter of each bag are rectilinear and each bag includes one perimeter side having a hand resealable seal.

9. A method for producing a bag for protecting rice from insect pests harmful to stored rice, the method comprising:
forming a plastic bag from a top and a bottom member by sealing the top and bottom member along perimeter thereof; and
disposing a one-way valve in one of the top and bottom member proximate the perimeter thereof.

10. A method for storing rice in a manner protecting the stored rice from insect pests harmful to stored rice, the method comprising:
forming a plastic bag from a top and a bottom member by sealing the top and bottom member along a bottom and side thereof;
filing the formed bag with rice; and
sealing the filed bag along a top thereof.
